(19) United States
(12) Patent Application Publication
(10) Pub. No.: US 2007/0065357 A1
(43) Pub. Date: Mar. 22, 2007

(54) Cellular phone with push to talk over cellular (POC) service

(75) Inventor: Chin-Hui Chien, Taipei Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/229,788

(22) Filed: Sep. 19, 2005

(51) Int. Cl. C01F 7/76; C01G 37/10; C01D 5/10

(52) U.S. Cl. 423/518

(57) ABSTRACT

A method for push to talk over cellular (PoC) operation is provided. The method is applied in a cellular phone with a PoC button associated. The method comprises: (A) detecting the PoC button has been pressed and released a first time, wherein the time length the PoC button has been pressed does not exceed a first time limit; (B) detecting the PoC button has been pressed and released a second time, wherein the time length the PoC button has been pressed the second time does not exceed the first time limit, wherein the time difference between the first and second times of releasing the PoC button does not exceed a second time limit; (C) assigning the PoC button a pressed button status when the PoC button has been pressed and then released the second time; (D) sending a floor grant request to establish an outward voice communication; (E) receiving a floor grant message; and (F) establishing and maintaining the outward voice communication wherein the PoC button is associated with the pressed button status.

### BACKGROUND

The invention relates to a cellular phone and in particular a cellular phone that provides a push to talk over cellular (PoC) service.

Push to talk over cellular (PoC) introduces a direct one-to-one and one-to-many voice communication service to the cellular network. PoC provides a walkie-talkie-like service. The most powerful feature of PoC is a group talk service that allows many users to join the same session. PoC is based on half duplex VOIP (voice over IP) technology over the second generation GSM/GPRS network. A push to talk call is a one-way communication: while one person speaks, the other(s) listen. Typically, a cellular phone supporting a PoC service has a dedicated PoC button. A PoC service provides instant voice connectivity to the party on the other end. When a user wants to talk, he presses and holds down a PoC button on the phone, or holds down the mouse button or space bar on a computer. Letting go of the button allows the other person to talk. The turns to speak are granted by pressing a push to talk button on a first come, first serve basis. Thus, PoC requires a control mechanism to control the turns to speak among a plurality of users within a preset group. This control mechanism defines a “floor” (i.e., the turn to speak). The user gains the turn to speak when he or she owns the floor.

FIG. 1 illustrates a communication system providing a PoC service. PoC clients 120 and 130 are cellular phones supporting PoC services. PoC client 120 comprises a PoC button 12a, and PoC client 130 comprises a PoC button 13a. PoC clients 120 and 130 communicate with a PoC server 110 via a PoC network 100. The PoC network 100 can be a second generation GSM/GPRS network, or other network supporting a half duplex VOIP technology.

FIGS. 2A and 2B illustrate a flowchart of a conventional method of operating a PoC service. When a user of PoC client 120 wants to speak, a turn to speak must be obtained by first pressing PoC button 12a(step S210). PoC Client 120 sends a request to PoC server 110 to obtain the “floor” (step S220). A PoC button Status is set to “pressed” (step S230) while the PoC button continues to be pressed. PoC client 120 then waits for a floor grant message from PoC server 110 (step S260). If the user decides while waiting that he no longer wish to speak, PoC button 12a is released (step S240), and the PoC button status is set to “not pressed” (step S250). When the floor is granted to PoC client 120 in response to the request, a grant message is sent to PoC client 120. In step S300, the grant message is received by PoC client 120. In step S310, it is determined whether the PoC button status is set as “pressed”. If the PoC button status is set as “not pressed”, a release request is sent from PoC client 120 to PoC server 110 to release the floor (350). If the PoC button status is set as “pressed”, a signal, such as a “beep” sound, is emitted to indicate that a talk session may be begin(step S320). The voice transmitted from PoC client 120 is emitted from a built-in speaker in PoC client 130. The user continues to press the PoC button 12a during the entire talk session (step S330). When the PoC button is released in step S340, PoC client 120 sends a request to release the floor to PoC server (step S350).

In the conventional method, a user must continue pressing a PoC button during the entire talk session. During a long talk session, continuing to press the button may be inconvenient and cause physical discomfort.

### SUMMARY

A method for push to talk over cellular (PoC) operation is provided. The method is applied in a cellular phone with a PoC button associated. The method comprises: (A) detecting the PoC button has been pressed and released a first time, wherein the time length the PoC button has been pressed does not exceed a first time limit; (B) detecting the PoC button has been pressed and released a second time, wherein the time length the PoC button has been pressed the second time does not exceed the first time limit, wherein the time difference between the first and second times of releasing the PoC button does not exceed a second time limit; (C) assigning the PoC button a pressed button status when the PoC button has been pressed and then released the second time; (D) sending a floor grant request to establish an outward voice communication; (E) receiving a floor grant message; and (F) establishing and maintaining the outward voice communication wherein the PoC button is associated with the pressed button status.

Another method for push to talk over cellular (POC) operation is provided. The method is applied in a cellular phone with a PoC button associated. The method comprises: (A) providing a PoC button associated with a cellular phone; (B) detecting the PoC button has been pressed a first time; (C) sending a floor grant request for establishing an outward voice communication after the PoC button has been pressed the first time; (D) detecting that the PoC button is kept on being pressed until a floor grant message is then received; (E) receiving a floor grant message; (F) detecting the PoC button has been released a first time after the floor grant message is received; (G) assigning the PoC button a pressed button status when the PoC button has been pressed and released the first time; and (H) establishing and maintaining the outward voice communication, wherein the PoC button is associated with the pressed button status.

### DESCRIPTION OF THE DRAWINGS

The invention can be more fully understood by reading the subsequent detailed description and examples with references made to the accompanying drawings, wherein:

FIG. 1 illustrates a communication system providing a PoC service;

FIGS. 2A and 2B illustrate a flowchart of a conventional method of operating a PoC service;

FIG. 3 illustrates a communication system providing a PoC service;

FIGS. 4A and 4B illustrate configurations for a Push-To-Talk operation setting;

FIGS. 5A and 5B illustrate a Push-To-Talk operation for a long talk session; and

FIGS. 6A and 6B illustrate another Push-To-Talk operation suitable for a long talk session.

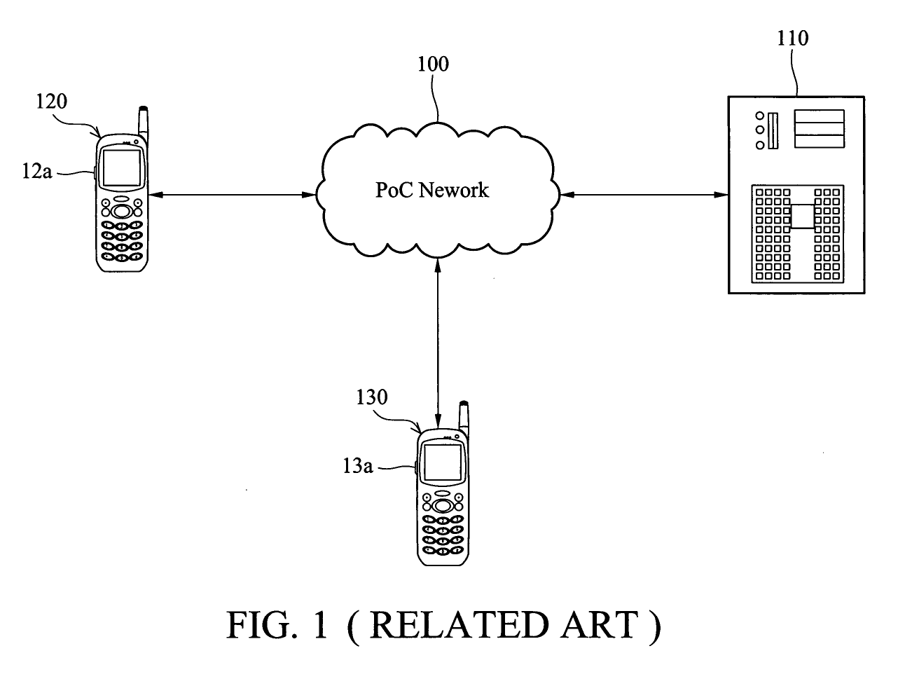

### DETAILED DESCRIPTION

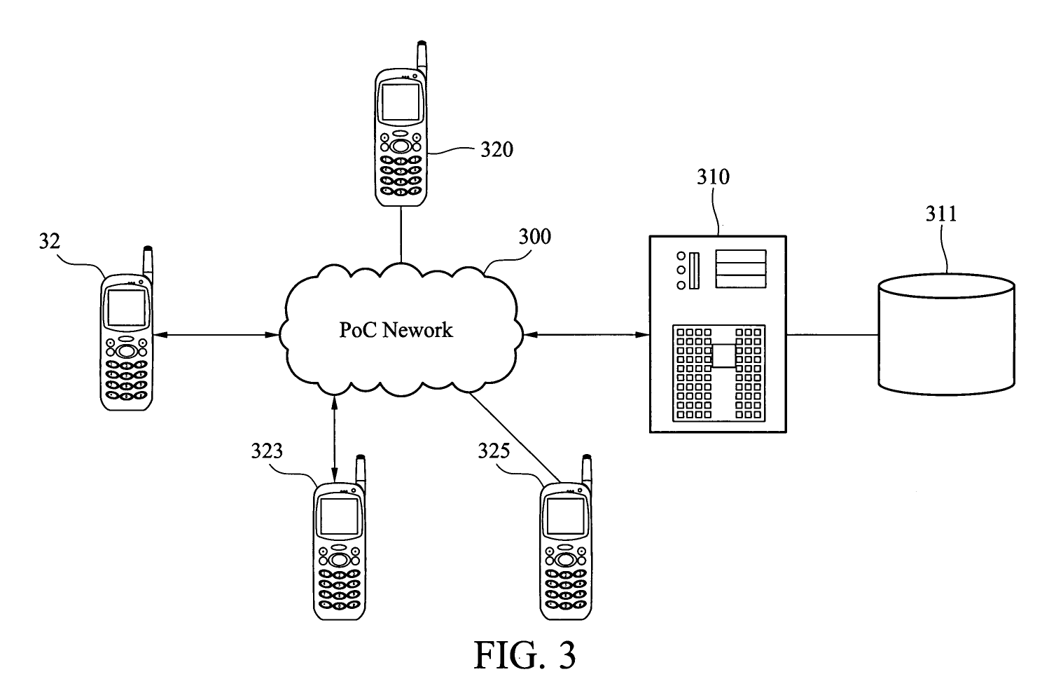

The invention will now be described with reference to FIGS. 3 through 6, which generally relate to operations of push to talk over cellular (PoC) service.

In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures corresponds to the Figure number, with the exception that the same reference number is used throughout to refer to an identical component which appears in multiple figures.

FIG. 3 illustrates a communication system providing a PoC service. The push to talk service is implemented using a Push to Talk application server (PTT server) 310 in an IP Multimedia Subsystem (IMS) frame. The PTT server 310 handles call set-up signaling for Push to Talk calls, reservation of talk spurts for one speaker at a time and real-time routing of IP packets, and carrying talk spurts to the recipients. The PTT server 310 also provides an interface to an operator system 340, and creates charge detail records, which can be used as a basis for billing. The Push to Talk scales to multimillion user networks with several networked Push to Talk application servers. A Push to Talk user database 311 stores data pertaining to provisioned users, their access rights, authentication information and preconfigured group membership. The users and talk groups can be arranged in the database in organization-specific closed user groups.

PoC clients 320, 321, 323, and 325 are cellular phones supporting PoC services. PoC clients 320, 321, 323, and 325 comprise PoC buttons 320a, 321a, 323a, and 325a, respectively. PoC clients 320, 321, 323, and 325 communicate with a PoC server 310 via a PoC network 300. The PoC network 300 can be a second generation GSM/GPRS network, or other network supporting a half duplex VOIP technology.

Users can form a talk group on an ‘ad hoc’ basis without having to contact their service providers, which facilitates spontaneous and flexible group communication. A user using PoC client 320 can select a desired phone number or talk group from a phone book stored in the PoC client 320.

For example, users A, B, and C use PoC clients 320, 321, and 323, respectively. Users A, B, and C are personnel in a manufacturing system, wherein user A is a supervisor, and users B and C are operators. When user A wants to know whether user B and C have been confronted by any problem, he sets up a PTT call to PoC clients 321 and 323. First, user A has to obtain a grant message for a turn to speak (or a ‘floor’). At this time, the PTT call is intended for a short query. PoC button 320a is pressed, and a request for a floor grant message is sent to PoC server 310. When receiving a floor grant message, an audio signal, such as a “beep”, is emitted to indicate that a talk session may begin, and user A starts to speak. Typically, about 2 seconds are required to obtain the floor grant message. User A continues pressing PoC button 320a until the intended short query is issued, for example, ‘Everything OK’. PoC button 320a is released after the short query is uttered. The voice transmitted from PoC client 320 is emitted from built-in speakers in PoC clients 321 and 323. If user B or C wants to say something to user A or the entire group, the floor must first be obtained.

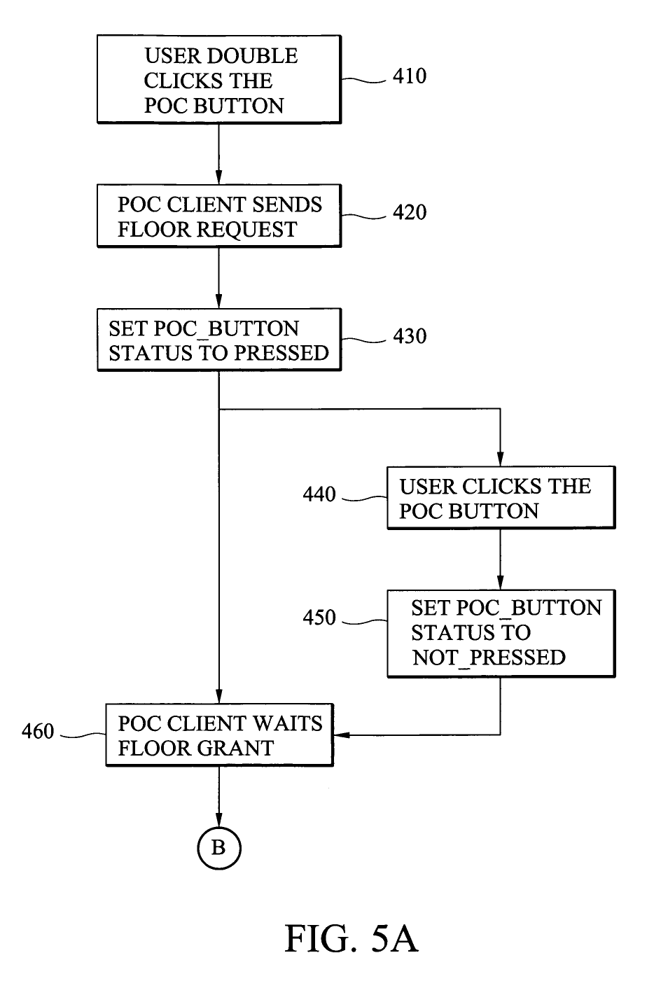

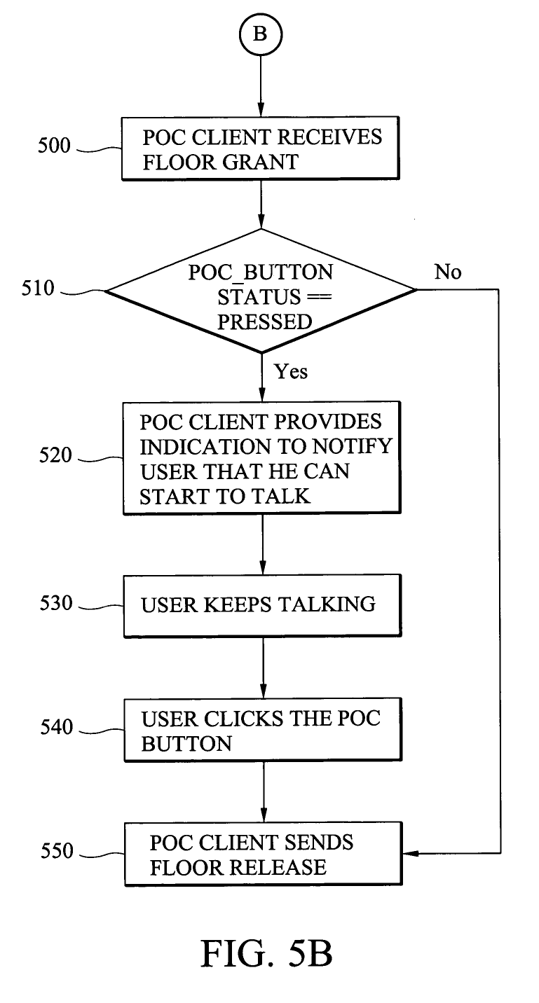

For example, user B is confronted with a tool shut down situation, and wants to inform user A of the situation. If the desired PTT operation is enacted, user B must continue pressing PoC button 321a for the entire talk session. Details of the tool shut down situation, however, cannot be provided using just one or two words, and since user B is engaged in other activities, it may be inconvenient to describe the situation using the described PTT operation. Another PTT operation illustrated in FIGS. 5A and 5B is detailed as the following.

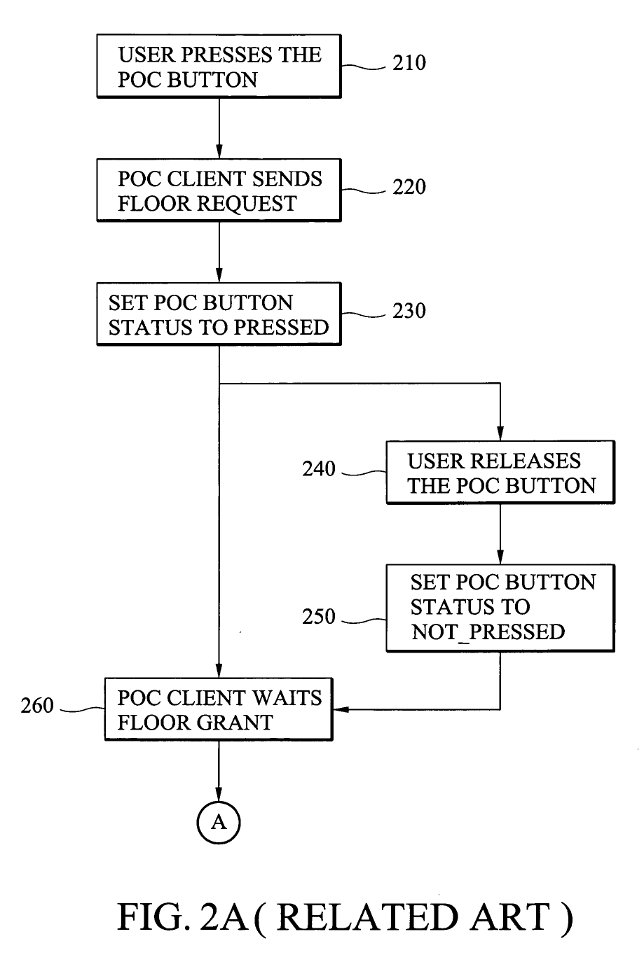

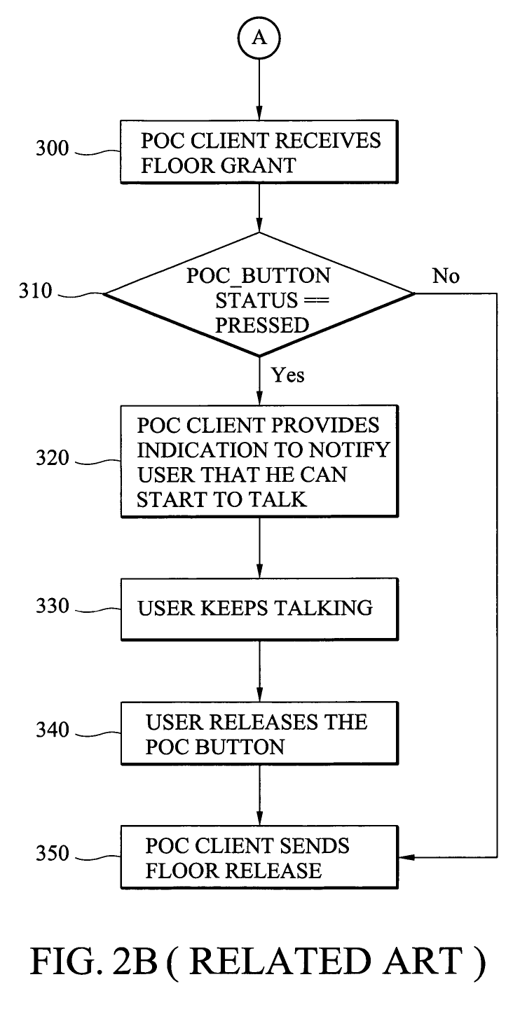

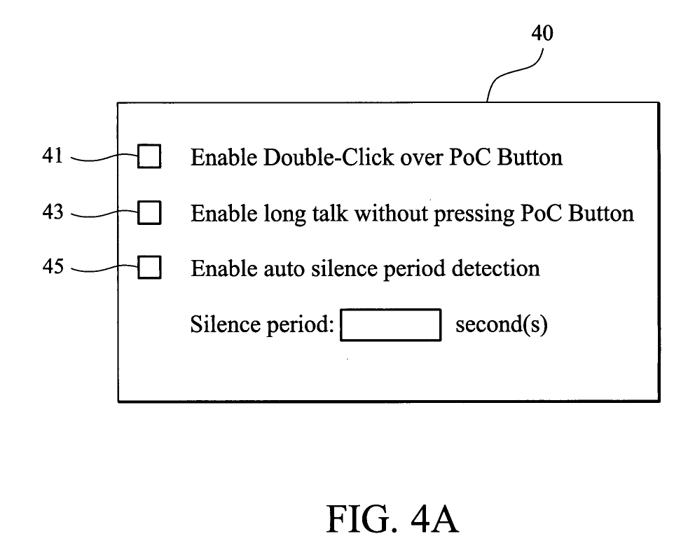

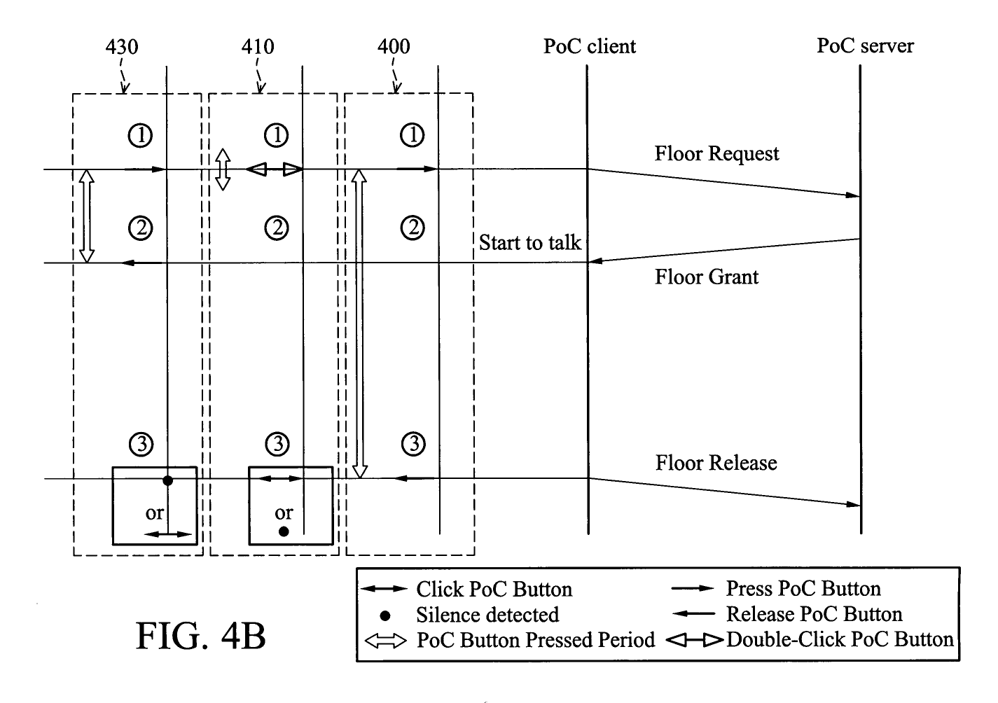

The described PTT operations can be configured to meet special needs. FIG. 4A illustrates configuration of PTT settings. FIG. 4A illustrates a default PTT operation setting configuration. In setting display 40, check boxes 41, 43, and 45 are presented. When none of the three check boxes is selected, a default PTT operation (as described in FIG. 2A & 2B) is configured. When check box 41 is selected, a “double-click” PTT operation is enabled. When check box 43 is selected, a “long talk without pressing PoC button” PTT operation is enabled. When check box 45 is selected, a silence threshold must be set, and the silence detection mechanism is enabled.

Using FIG. 4B as an example, when none of check boxes 41, 43, and 45 is selected, a default PTT operation is performed (as shown in condition 400). When check box 41 is selected, a “double-click” PTT operation is enabled (as shown in condition 410). When check box 43 is selected, a “long talk without pressing PoC button” PTT operation is enabled (as shown in condition 430). When check box 45 is selected, a silence threshold must be set, and the silence detection mechanism is enabled.

When check box 41 is selected, user needs not to press PoC button during a talk session by double-clicking the PoC button to initiate the “double-click” PTT operation. Additionally, when check box 41 is selected, check box 45 can be selected optionally. The silence detection is preformed according to the silence period determined by the user.

When check box 43 is selected, user needs to press PoC button until a floor grant is received, and then the PoC button is released during a talk session. Additionally, when check box 43 is selected, check box 45 can be selected optionally. The silence detection is preformed according to the silence period determined by the user.

It should be noted that the default PTT operation, the “double-click” PTT operation, and the “long talk without pressing PoC button” PTT operation are not exclusive. That is, when both check boxed 41 and 43 are selected, the cellular phone can be operated in one of the tree operations according to the pressing status of the PoC button. For example, when the user presses the PoC button and keeps on pressing the PoC button even when the floor grant message is received and during the talk session, it can be known that the user operates the cellular phone in the default PTT operation.

When the user double-clicks the PoC button, it can be known that the user operates the cellular phone in the “double-click” PTT operation. And when the user presses the PoC button and then releases the PoC button when the floor grant message is received, it can be known that the user operates the cellular phone in the the “long talk without pressing POC button” PTT operation.

FIGS. 5A and 5B illustrate a PTT operation for a long talk session (i.e. the “double-click” PTT operation). Referring to FIG. 5A, when user B wants to speak to user A, a turn to speak must be obtained by pressing and releasing PoC button twice, wherein the time length the PoC button has been pressed does not exceed a first time limit (step S410). Here, pressing and releasing PoC button twice and the time length the PoC button has been pressed is within a predetermined short period of time can also be referred to as “double-clicking” PoC button. PoC Client 321 sends a request to PoC server 310 to obtain the “floor” (step S420). A PoC button status is set to “pressed” when the PoC button is pressed and released twice and the time length the PoC button has been pressed is within a predetermined short period of time, i.e. when the PoC button is double-clicked (step S430). PoC client 321 then waits for a floor grant message from PoC server 310 (step S460). If user B does not want to speak anymore during the waiting, PoC button 321a is pressed and released (clicked) (step S440), and the PoC button status is set to “not pressed” (step S450).

When the floor is granted to the user B in response to the request, a grant message is sent to PoC client 321. Referring to FIG. 5B, in step S500, the floor grant message is received by PoC client 321. In step S510, it is determined whether the PoC button status is set to “pressed”. If the PoC button status is set as “not pressed”, a release request is sent from PoC client 321 to PoC server 310 to release the floor (550). If the PoC button status is set as “pressed”, an audio signal, such as a “beep”, is emitted indicating that a talk session may begin (step S520). User B reports the tool shut down situation to user A without pressing the PoC button 321a, that is, the PoC button 321a is released during the entire talk session (step S530). When user B finishes his report and wants to close the talk session, he clicks PoC button 321a in step S540. PoC client 321 then sends a request to release the floor to PoC server 310 (step S550). If user B is engaged and cannot clicks PoC button 321a when he finishes the report, a silence detection mechanism can be used for closing the talk session automatically. According to the silence detection mechanism, if user B is silent for a preset period of time, the PoC button status is reset to ‘not pressed’, and a request to release the floor is automatically sent to PoC server 310. The preset period of time can be, for example, 5 or 10 seconds.

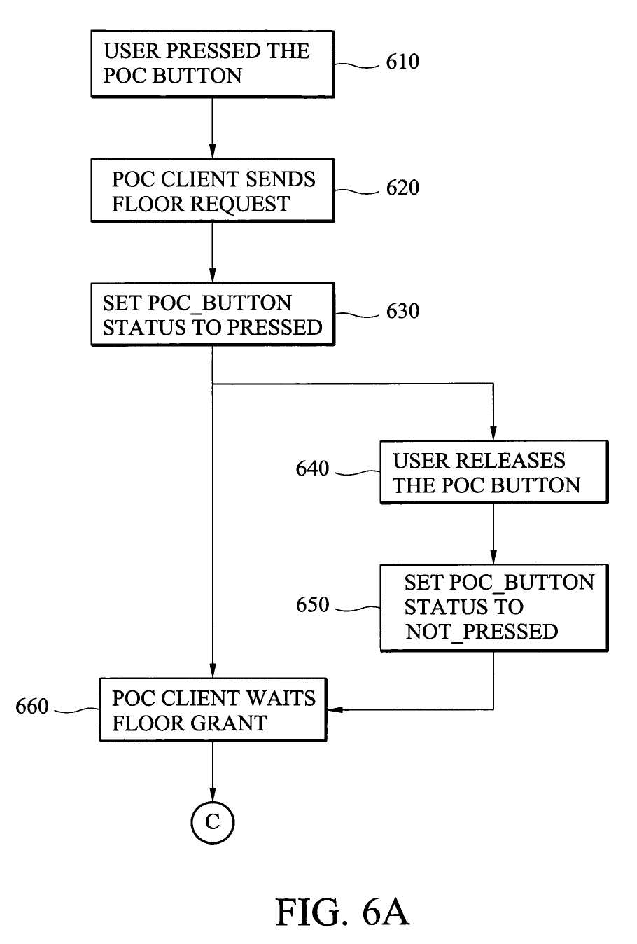

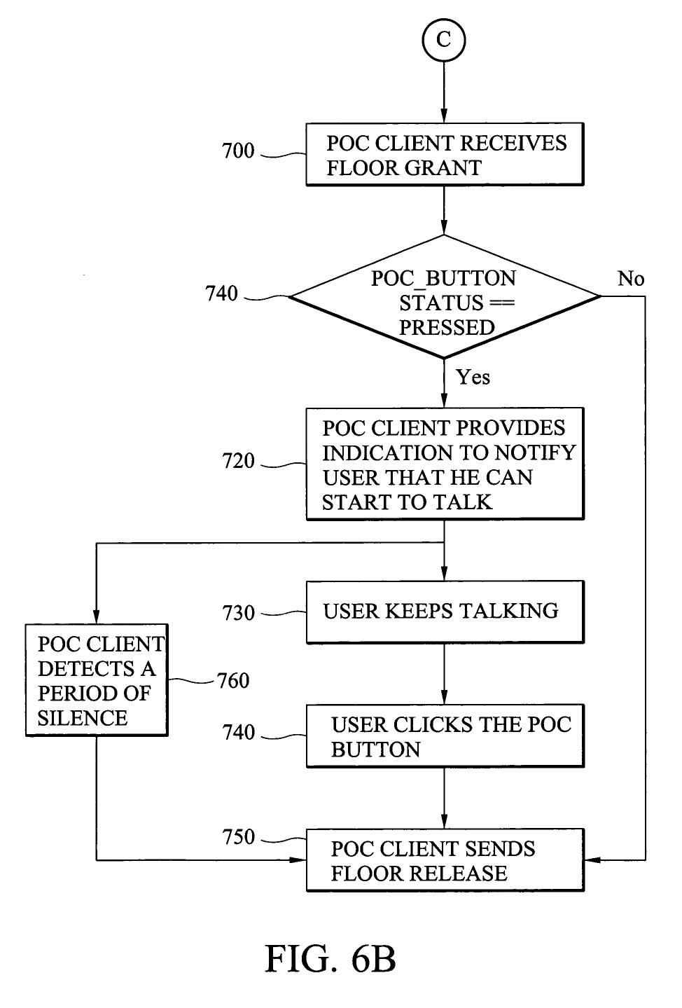

FIGS. 6A and 6B illustrate another PTT operation suitable for a long talk session (i.e. the “long talk without pressing PoC button” PTT operation). After user A understands what user B has said, he may want to instruct both users B and C to handle the tool shut down situation. User A selects a talk group comprising PoC clients 321 and 323, and obtains a floor grant by pressing PoC button 320a at first (step S610). PoC Client 320 sends a request to PoC server 310 to obtain the “floor” (step S620). A PoC button status is set to “pressed” when PoC button 320a continues to be pressed (step S630). PoC client 320 then waits for a floor grant message from PoC server 310 (step S660) If user A does not want to speak anymore during the waiting, PoC button 320a is released (step S640) and the PoC button status is set to “not pressed” (step S650).

When the floor is granted to the user in response to the request, a floor grant message is sent to PoC client 320. Referring to FIG. 6B, in step S700, the floor grant message is received by PoC client 320. In step S710, it is determined whether the PoC button status is set to “pressed”. If the PoC button status is set as “not pressed”, a release request is sent from PoC client 320 to PoC server 310 to release the floor (step S750). If the PoC button status is set as “pressed”, an audio signal, such as a “beep”, is emitted to indicate that a talk session may begin (step S720). User A gives instructions for handling the tool shut down situation to users B and C, while PoC button 321a is released during the entire talk session (step S730). When user A finishes his instruction and wants to close the talk session, he clicks PoC button 320a in step S740. PoC client 320 then sends a request to release the floor to PoC server 310 (step S750). If user A is engaged and cannot click PoC button 320a when he finishes speaking, a silence detection mechanism can be used for closing the talk session automatically (step S760). According to the silence detection mechanism, if user A is silent during a preset period of time, the PoC button status is reset to ‘not pressed’, and a request to release the floor is automatically sent to PoC server 310. The preset period of time can be, for example, 5 or 10 seconds.

While the invention has been described by way of example and in terms of several embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for push to talk over cellular (PoC) operation, comprising:
providing a PoC button associated with a cellular phone;
detecting the PoC button has been pressed and released a first time, wherein the time length the PoC button has been pressed does not exceed a first time limit;
detecting the PoC button has been pressed and released a second time, wherein the time length the PoC button has been pressed the second time does not exceed the first time limit, wherein the time difference between the first and second times of releasing the PoC button does not exceed a second time limit;
assigning the PoC button a pressed button status when the PoC button has been pressed and then released the second time;
sending a floor grant request to establish an outward voice communication;
receiving a floor grant message; and
establishing and maintaining the outward voice communication, wherein the PoC button is associated with the pressed button status.

2. The method of claim 1, further detecting the PoC button has been pressed and released a third time after the outward voice communication has been established, and sending a floor release request.

3. The method of claim 1, further comprising determining a time length of a silent period after the outward voice communication has been established, and sending a floor release request when the silent period exceeds a third time limit.

4. The method of claim 1, further assigning the PoC button a non-pressed button status when the button is pressed and released a third time before the floor grant message is received.

5. The method of claim 4, further sending a floor release request if the PoC button is associated with a non-pressed button status when the floor grant message is received.

6. A method for push to talk over cellular (PoC) operation, comprising:
providing a PoC button associated with a cellular phone;
detecting the PoC button has been pressed a first time;
sending a floor grant request for establishing an outward voice communication after the PoC button has been pressed the first time;
detecting that the PoC button is kept on being pressed until a floor grant message is then received;
receiving a floor grant message;
detecting the PoC button has been released a first time after the floor grant message is received;
assigning the PoC button a pressed button status when the PoC button has been pressed and released the first time; and
establishing and maintaining the outward voice communication, wherein the PoC button is associated with the pressed button status.

7. The method of claim 6, further comprising detecting the PoC button has been pressed and released a second time after the outward voice communication has been established, and sending a floor release request.

8. The method of claim 6, further comprising after the outward voice communication has been established, determining a time length of a silent period, and sending a floor release request when the silent period exceeds a time limit.

9. The method of claim 6, further assigning the PoC button a non-pressed button status when the button is released the first time before the floor grant message is received.

10. The method of claim 9, further sending a floor release request if the PoC button is associated with the non-pressed button status when the floor grant is received.

11. A cellular phone implementing push to talk over cellular (PoC) operation, comprising:
a PoC button;
a memory storing program code for implementing the PoC operation, and a PoC button status associated with the PoC button; and
a controller executing the program code, performing steps of:
detecting the PoC button has been pressed and released a first time, wherein the time length the PoC button has been pressed does not exceed a first time limit;
detecting the PoC button has been pressed and released a second time, wherein the time length the PoC button has been pressed the second time does not exceed the first time limit, wherein the time difference between the first and second times of releasing the PoC button does not exceed a second time limit;
assigning the PoC button a pressed button status when the PoC button has been pressed and then released the second time;
sending a floor grant request to establish an outward voice communication;
receiving a floor grant message; and
establishing and maintaining the outward voice communication, wherein the PoC button is associated with the pressed button status.

12. The cellular phone of claim 11, wherein the controller further detects the PoC button has been pressed and released a third time after the outward voice communication has been established, and sending a floor release request.

13. The cellular phone of claim 12, wherein the controller further determines a time length of a silent period after the outward voice communication has been established, and sending a floor release request when the silent period exceeds a third time limit.

14. The cellular phone of claim 12, wherein the controller further assigns the PoC button a non-pressed button status when the button is pressed and released a third time before the floor grant message is received.

15. The cellular phone of claim 12, wherein the controller further sends a floor release request if the PoC button is associated with a non-pressed button status when the floor grant message is received.

16. A cellular phone implementing push to talk over cellular (PoC) operation, comprising:
a PoC button;
a memory storing program code for implementing the PoC operation, and a PoC button status associated with the PoC button; and
a controller executing the program code, performing steps of:
detecting the PoC button has been pressed a first time;
sending a floor grant request for establishing an outward voice communication after the PoC button has been pressed the first time;
detecting that the PoC button is kept on being pressed until a floor grant message is then received;
receiving a floor grant message;
detecting the PoC button has been released a first time after the floor grant message is received; assigning the PoC button a pressed button status when the PoC button has been pressed and released the first time; and
establishing and maintaining the outward voice communication wherein the PoC button is associated with the pressed button status.

17. The cellular phone of claim 16, wherein the controller further detects the PoC button has been pressed and released a second time after the outward voice communication has been established, and sending a floor release request.

18. The cellular phone of claim 16, wherein the controller further determines a time length of a silent period after the outward voice communication has been established, and sends a floor release request when the silent period exceeds a time limit.

19. The cellular phone of claim 16, wherein the controller further assigns the PoC button a non-pressed button status when the button is released the first time before the floor grant message is received.

20. The cellular phone of claim 19, wherein the controller further sends a floor release request if the PoC button is associated with the non-pressed button status when the floor grant is received.
